(19) United States
(12) Patent Application Publication
(10) Pub. No.: US 2017/0231732 A1
(43) Pub. Date: Aug. 17, 2017

(54) FLOSSING DEVICE

(71) Applicant: Garret Randolph Moss, Jackson, WY (US)

(72) Inventor: Garret Randolph Moss, Jackson, WY (US)

(21) Appl. No.: 15/043,549

(22) Filed: Feb. 13, 2016

(51) Int. Cl. A61C 15/02

(52) U.S. Cl. CPC A61C 15/02

(57) ABSTRACT

Flossing device according to the present invention comprise a flossing material attachment platform, a handle and a plurality of flossing material attached to the platform. The device is put into the users mouth and chewed thereby compressing the flossing material and producing tooth joint and subgingival penetration. The plurality of flossing material is systematically trimmed to varying lengths creating an interior angle of 90 degrees which automatically positions the flossing material at the optimum angle in relation to the tooth surface. While the device is chewed in the users mouth, the device dislodges bacteria from between teeth, along the side plane of the tooth, as well as the sulcular pocket. In the process this new device also gently stimulates and massages the gum surface promoting blood circulation and the healing properties associated with increased circulation. Because this new device is painless and user friendly, the frequency of use, compared to current flossing devices, is dramatically increased thereby resulting in much healthier and less tender gums.

### BACKGROUND OF THE INVENTION

This invention relates generally to oral cleansing devices and more particularly to flossing devices.

Present flossing techniques and material do not present a simple and comfortable method of dislodging particulates, especially at the joint between teeth and along the gingival collar at the side plane of the tooth. There are many devices designed to aid in the use of traditional string floss, but they are all time consuming, require exceptional dexterity, require changing from one device to another and require specific training to use properly. The traditional string floss is also painful and uncomfortable to use resulting in very limited and less consistent use. Therefore, it is imperative to have an elective device that is user friendly, promoting consistent use resulting in greatly improved overall dental health.

In an exemplary embodiment of the present invention, there is disclosed a flossing device comprising of a flossing material platform, and a plurality of flossing material attached to or inserted into the platform. The flossing material is essentially fixed multiple semi-rigid flossing material. The attachment platform may have different shapes and dimensions. The primary embodiment has a flat side where the flossing material is protruding, the opposite side being slightly rounded outward. The flossing material is inserted to the flat side of the platform at 90 degrees. The lengths of the flossing material is trimmed to varying lengths with the tips forming an interior 90 degree angle.

The intent of this invention is a new form of flossing device that is actually effective and comfortable to use thereby promoting consistent use, which is the primary detriment to current methods. The benefits from this device are achieved through a new design as well as alternate method of use from traditional flossing. The primary benefit is to dislodge bacteria from between teeth, along the side plane of the tooth, especially at the subgingival level known as the sulcular pocket. In the process, this device also gently stimulates the overall gum surface and sulcus. Because of the comfort and ease of use, a more consistent daily use and stimulation is achieved, resulting in much healthier, less bleeding and tender gums. These results are achieved in a rather short period of time after consistent utilization of this invention.

The primary unique design features of the new device are:
1. semi-rigid material that yields moderate stiffness and/or flexibility
2. plurality of flossing material per unit
3. formation of interior angle with tips of flossing material
4. rounded opposite side of floss malarial attachment platform

The critical and unique component of this new device is the method of use. To achieve the intended and effective results users are instructed to chew the device. The effects of chewing the device are such that the flossing material is pushed into the gum sections between and around the entire tooth. This perpendicular pressure causes the flossing material to penetrate the subgingival area to effectively clean and loosen calculus from the sulcular pocket which is the area of the teeth surface hidden by the gum tissue and the area that is not reached or cleaned by ordinary brushing. Traditional, or ordinary brushing yields a situation where bristles are drawn forward, backward, up and down in a motion where the bristle tips are always pointing away and drawn away from the area to be cleaned and does not penetrate between the teeth or the area below the gum line. This area is the most critical in fighting gingivitis and the onset of gum disease. Because traditional string flossing is so painful and uncomfortable this area is ignored on a daily basis and only cleaned sporadically. This is especially evident with poorly aligned or overlapping teeth not allowing traditional brushing or flossing any contact with the gingival collar, let alone the subgingival area. The user will find that because it is comfortable to use every day that in a short time period their gums will no longer bleed, ho longer be tender, plaque build up is prevented entirely and that their teeth have that “clean feeling” everyday that is currently only experienced after a professional cleaning.

It is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more apparent from the following detailed description and the accompanying drawings in which similar elements are given similar reference numerals.

FIG. 1 is a perspective view of a flossing device having a common handle design with modified head and flossing material configuration according to one embodiment of the present invention.

FIG. 2 is a perspective view of the embodiment of FIG. 1 in use

FIG. 3 is a perspective view of the embodiment of FIG. 1 in use

### DESCRIPTION OF THE EMBODIMENT

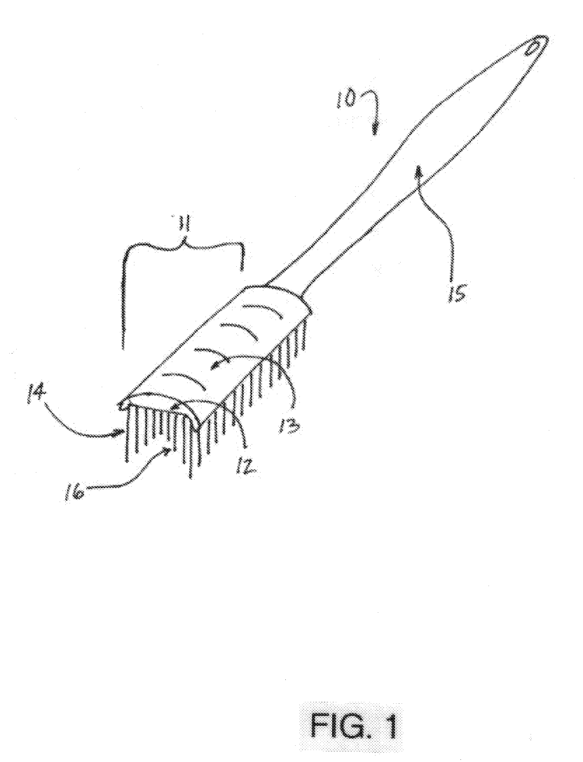

Referring to FIG. 1, there is disclosed a flossing device according to the embodiment of the present invention. The embodiment of the flossing device 10 comprises a handle 15 attached to a flat attachment platform 12 that serves as an attachment surface for the flossing material 14. The opposite side of the flat attachment platform 12 is a uniformly curved surface 13 serving as a compression surface or pad. The portion of the embodiment that is to be inserted into the mouth to serve the function of the invention is shown as 11, comprising of the attachment platform 12, the flossing material 14 and the curved compression surface 13. The length of the flossing material is trimmed such that the tips form an interior angle 16 of approximately 90 degrees. This flossing material tip formation of 90 degrees is critical and serves to automatically set the angle of the flossing material at 45 degrees to the surface of the tooth when being compressed by the users chewing action. This insures the penetration of the flossing material between the tooth crevasse and to the subgingival area 17 for proper dislodging of subgingival plaque and tartar. The length of the flat attachment platform 12 is approximately 0.75 inches to 1.25 inches. The width of the flat attachment platform is approximately 0.33 inches and 0.58 inches. The flat attachment platform 12 and the handle 15 shall be a single unit made of extendable material including but not limited to one of polymer, natural rubber, and/or a combination thereof. The flossing material 14 shall be made of similar material used in traditional floss only of the semi-rigid nature or shall be made of material similar to that at the bristles in a traditional toothbrush, such that they offer moderate stiffness allowing the tips to be pushed forward along the tooth surface and gently into the sulcular pocket.

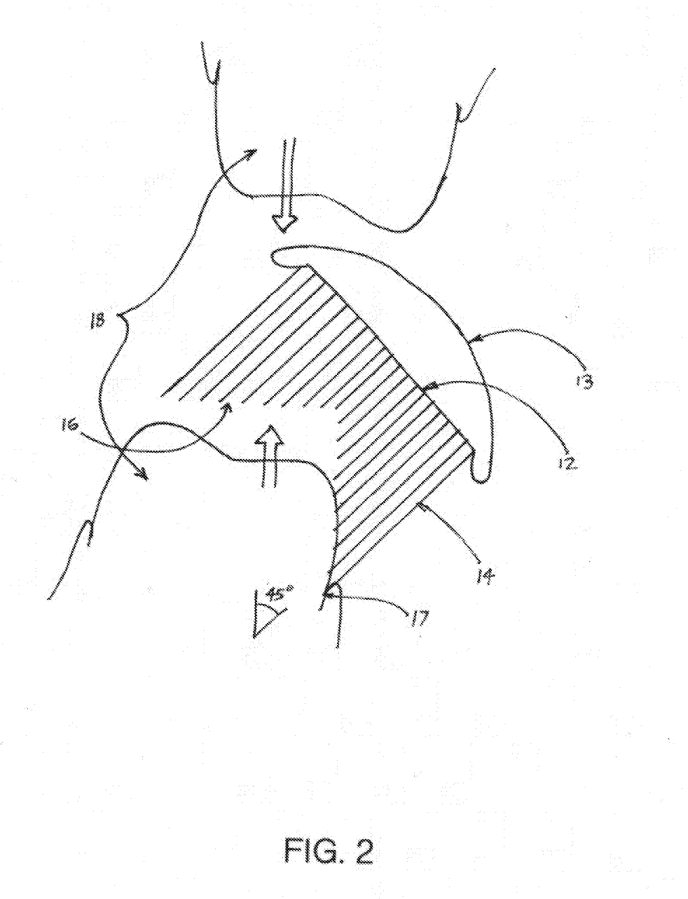

As shown in FIG. 2, when the embodiment of the device 10 is used as prescribed (chewed) the tips of the flossing material 14 are pushed forward, in relation to their length, resulting in vertical compression, by the opposing teeth 18. This movement is unique and contrary to current cleaning devices that produce a perpendicular motion, to the length of the bristle, that essentially draws the tip away from the surface and point of focus.

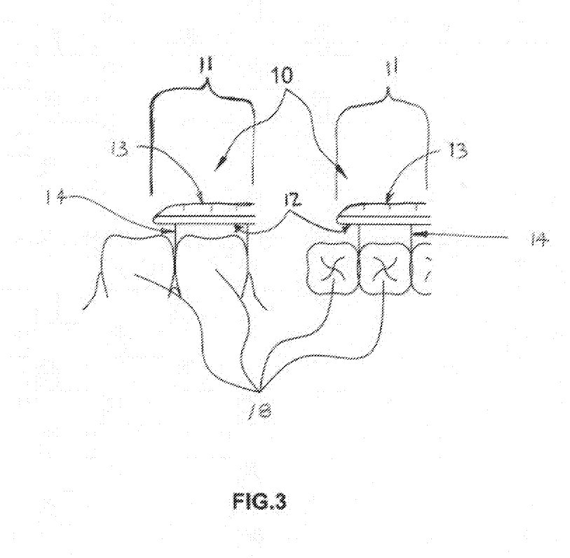

FIG. 3 clearly demonstrates that the vertical compression produced by the embodiment of the device 10 results in greater insertion of the flossing material into the tooth joint, and therefore increased effectiveness in dislodging plaque at the most critical area.

What is claimed is:

1. A flossing device comprising:
A flat flossing material attachment platform
A plurality of flossing material attached to or inserted into the flat side of the attachment platform.
A rounded surface opposite of the flat flossing material attachment platform serving as a compression surface
A handle attached to one end of the attachment platform

2. The flossing device of claim 1 wherein the plurality of flossing material is trimmed to varying lengths such that the tips form an interior angle of 90 degrees.

3. The flossing device of claim 2 wherein the shape of the interior angle of the tips accurately and automatically positions the flossing material at the optimum 46 degrees to the tooth surface to be cleaned.

4. The flossing device of claim 3 wherein the flossing material is of semi-rigid nature that yields moderate stiffness or flexibility producing a stimulating and massaging feel while penetrating and cleaning below the gum line.

5. The flossing device of claim 4 wherein the flat flossing material attachment platform is approximately between 0.75 inches 1.25 inches in length and is approximately 0.33 inches and 0.58 inches in width.

6. The flossing device of claim 5, wherein the flat flossing material attachment platform and adjoining handle is a single unit made of extrudable material including one of polymer, natural rubber, and/or a combination thereof.

7. A method of using a flossing device comprising:
Providing a flossing device including a flat flossing material attachment platform and a plurality of flossing material attached to or inserted into the flat side of the attachment platform; putting the attachment platform with flossing material into users mouth; and chewing against the rounded side of the attachment platform thereby compressing the flossing material into the tooth joint and sulcular pocket dislodging debris and stimulating the gums.
